(19) United States
(12) Patent Application Publication
(10) Pub. No.: US 2004/0027487 A1
(43) Pub. Date: Feb. 12, 2004

(54) System to provide custom text and graphic information to a television system infrastructure

(76) Inventors: Robert J. Rzadzki, Crystal Lake, IL (US); Randolph W. Leodore, Crystal Lake, IL (US)

Correspondence Address: Roland W. Norris, Pauley Petersen Kinne & Erickson, Suite 365, 2800 West Higgins Road, Hoffman Estates, IL, 60195, US

(21) Appl. No.: 10/636,469

(22) Filed: Aug. 7, 2003

Related U.S. Application Data
(60) Provisional application No. 60/402,392, filed on Aug. 9, 2002.

(51) Int. Cl. H04N 7/08; H04N 7/16; H04N 7/00; H04N 11/00; H04N 5/445

(52) U.S. Cl. 348/563; 348/461; 725/137

(57) ABSTRACT

Apparatus for controlling a formerly passive-display television infrastructure, such as in a single-location commercial establishment, includes a text and graphical information input interface which uploads the text and graphical information, and the control information for its display, to dedicated control modules connected to each television. The apparatus can provide an addressable or a direct-wired ability for the operator to display text and graphics overlaid on an existing television channel at the operator's choice of time, text, and location on the screen. Alternate video source inputs may further be controlled to replace the currently displayed television channel for a selected amount of time.

This application claims priority from U.S. Provisional Application filing serial No. 60/402,392, filed Aug. 9, 2002.

### BACKGROUND OF THE INVENTION

Most commercial establishment video display systems are little more than hardwired passive display systems with a broadcast television signal feeding individual television sets. Coaxial cable or other wiring is routed through the establishment from a receiving antennae or the like to each individual set where the signal is demodulated and displayed. In the case of satellite dish or cable signal reception, the signal may be first routed to a satellite or cable signal decoder and from there the signal is then hardwired to one or more televisions. Within the commercial establishment, the owner has little choice but to passively display the broadcast signals. If private or alternative video sources are desired to be displayed, distribution switches and additional cabling must be added and manually controlled and/or an entire channel must be dedicated to the alternative video source. Alternatively, in some instances, an entire television or display monitor may be dedicated to such an “in house” alternative video source thereby limiting the utility of the display for other purposes.

Also, in the past, video overlay messaging, i.e., text or graphics, or both, overlaid onto another display image so that both are efficaciously visible, has been available only to entities with extensive technical equipment facilities. For example, broadcasters or cable companies can overlay message banners over normal programming. Television manufacturers have added the capability of instruction or information overlays about the set up or state of television operations to their sets. Unfortunately, local commercial establishments have in the past had to resort to stand alone scrolling LED banners or the like to deliver in-house message content, even though the establishment may have one or more televisions which passively display broadcast media.

Therefore, there is a need in the art for apparatus and methods which can utilize the existing video display infrastructure of such commercial establishments to provide the operators of such establishments with the capability and control of expanded utilization of the video displays. Such means and methods would desirably add a variety of new functionalities to the video displays while being easily and economically integrated into the existing video display infrastructure.

### SUMMARY OF THE INVENTION

The present invention provides a system for meeting the above-described needs by providing apparatus which connects to existing video display infrastructure, such as in a single-location commercial establishment, and can provide an addressable or a direct-wired ability for the operator to display text and/or graphics (hereinafter simply referred to as “text”) overlaid on an existing television channel (hereinafter sometimes referred to as “video overlay”) at the operator's choice of time, text, and location on the screen. Alternate video sources may further be selected to replace the currently displayed television channel for a selected amount of time under the operator's control.

The text and instructions for its display can be sent to a control module via a text overlay interface such as a personal computer (PC) or other digital text means. The control module may be constantly connected to the PC, or the text and control instructions may be downloaded to the control module, e.g., through a smaller digital-text means such as a personal digital assistant (PDA) or laptop computer containing control module interface software, which is then removed from connection with the control module.

Several end users of video systems could benefit from video overlay messaging capability. Commercial users might wish to use what are now passive video screens, used only for broadcast display, to better inform their patrons about various happenings in the establishment. For example, establishments such as inns, public houses, and the like, often have one or more televisions in place which could be used to publish drink or menu item specials, visually inform customers when their tables are ready, publish schedules of services, or the like.

Further, the end user may wish to have the ability to control the addition of alternative video content, e.g., locally generated video, internet feeds, or the like, into the display system of the establishment. Also, as a safety measure, an alternative video channel could be connected to sensors or alarm activators as an alert system to display exit locations and safety instructions in the event of misfortune. Video feeds from the internet might be displayed for additional sources of information concerning broadcast events or the like. A combination of video overlay messaging and the controlled selection of an alternative video channel might also be used to great effect.

Desirably, according to certain aspects of the invention, one control module is dedicated to one display monitor (the display or video monitor sometimes referred to herein for simplicity, and by way of example, as a television). Each control module desirably includes: (1) a controllable television tuner to select the signal during the alternative video channel selection process and demodulate commercial video signals to a baseband, or composite, video signal; (2) a controller with at least one microprocessor and associated memory to manage the downloading of text and operate communications with external devices and to control the controllable television tuner; and 3) a text overlay means for insertion of text into the composite video signal. The controller will include microcode to support control module operations. Software or firmware may be utilized for such functions. Each control module desirably further includes a communications line or port for connection to the digital text means, e.g., a bi-directional port, for instance a RS-232 serial bus enabled port, which uploads text data and control signals.

A remodulator may be included in the control module for modulating baseband composite video signals to televisions which require a modulated input. Operator interface means such as remote control circuitry and the like may further be included.

A first video in jack may be included with the control module for accepting a feed from an existing video distribution system, such as a cable, satellite, or broadcast feed. In some aspects of the invention, additional video inputs are desirably supplied for connection to alternate video sources, such as video cameras, playback devices, internet feeds, or the like. Each control module then has an output for connection to a corresponding television.

The text overlay interface contains a graphical user interface operating with high level software to interface the operator controlled digital text means with the control modules to allow the operator to select from predefined messages or create custom text on the television monitor. In one embodiment of the invention, a plurality of control modules can be controlled using a multiple serial port control module connected to a PC or other digital text means, so that each control module is able to run a different message as selected by the operator. The messages can be programmed, for example to scroll either vertically or horizontally at various speeds or “pop up” at programmed positions on the television screen. The messages can run continuously at specific times for a specific duration, or one time only.

In a second embodiment, each control module may be rack mounted, e.g. as an addressable card with edge connectors for cable in and cable out, and thus may share certain alternative video inputs and control signals and instructions which are distributed to the cards via a common bus. Each control module may have one or more video input jacks, or a bus connector input, or both. Each control module may have its inputs switchable to a video out jack, or a bus output, to place the data, alternative video, or commercial video on the existing cabling to the televisions.

A third embodiment may include a so called “agile modulator”, as known in the art, which can be selected to modulate both the control signals and text signals from the text input interface and the alternative video signals from the alternative video sources, whereupon all signals may be sent to the individual control modules on existing cabling of the video distribution infrastructure. The control modules will then operate as described above to provide text overlay and alternative video capability for the video monitors.

In each of the embodiments addressability may be provided to offer several advantages, including the ability to address the control modules individually or by groups according to a functional area. For example, the control modules may be grouped by floors in a large office building. Further, an alert system containing preprogrammed instructions, for example emergency or disaster instructions detailing exit or escape routes, can be preprogrammed into each individual control module or group of control modules or be contained on an alternate video source switchable to the control module output. Thus, for example, in the event of a fire, the control modules could be connected to a sensor in series with the building's alarm and/or sprinkler system to automatically switch the television controlled by the control module to an additional channel displaying exit routes or provide video overlay of emergency instructions, or both.

### BRIEF DESCRIPTION OF THE DRAWINGS

These and other objects and features of this invention will be better understood from the following detailed description taken in conjunction with the drawings wherein:

FIG. 1 is a block diagram of basic operations of the present invention.

FIG. 2 is an illustration of a stand alone box embodiment of the invention.

FIG. 3 is an illustration of a rack mounted embodiment of the present invention.

FIG. 4 is an illustration of an active modulator embodiment of the present invention.

### DETAILED DESCRIPTION OF THE PREFERRED EMBODIMENTS

Discussion of the control module parts will be given herein with respect to specific functional tasks or task groupings that are in some cases arbitrarily assigned to the specific components for explanatory purposes. It will be appreciated by the person of ordinary skill in the art that an apparatus according to the present invention may be arranged in a variety of ways, or that functional tasks may be grouped according to other nomenclature or architecture than is used herein without doing violence to the spirit of the present invention.

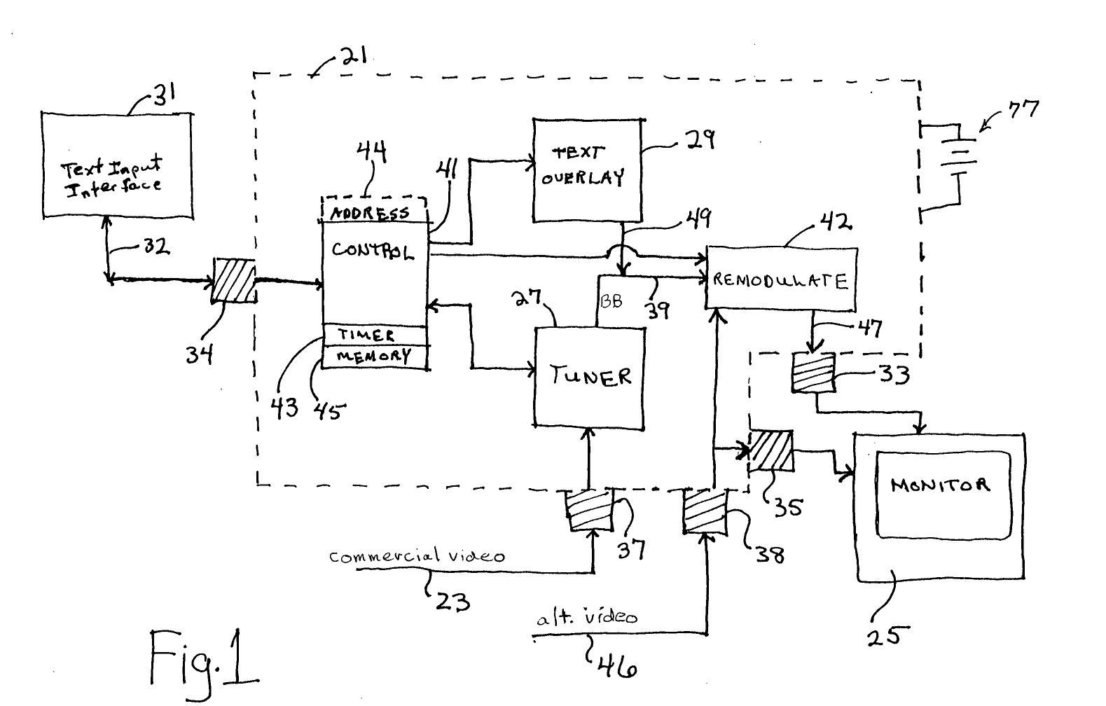

Referring to FIG. 1, apparatus according to the present invention may include a control module 21 according to one aspect of the invention which can be inserted in an existing television infrastructure between the existing commercial video feed 23 and the passive display monitor, or television, 25. Included within the control module 21 is a controllable television tuner 27 and text overlay means 29, as known in the art, for providing custom text and graphic information. Also desirable for the operation of the invention is a text input interface 31 allowing an operator to input at least one of preselected or free text (including graphics as defined herein) through a communications line 32, such as a bidirectional RS232 bus, USB, or the like, connected to a communications input 34 located on the control module 21.

The control module 21 includes a remodulated output 33 for connection to the monitor 25 and may include a baseband output 35 for the transmission of baseband, i.e. composite or unmodulated, video output. It will be understood by the person having ordinary skill in the art that such video outputs may further include audio signals. The control module 21 further includes a modulated signal input 37 for accepting modulated video signals 23 of a commercial video feed and routing the modulated signals 23 to the tuner 27. A baseband video signal input 38 for accepting baseband signals of so-called “alternative” video sources such as video cameras, playback devices, internet feeds, or the like is further desirably provided.

The tuner 27 is connected to the modulated commercial video signals 23 and demodulates the commercial video signals, and outputs a demodulated signal 39. One suitable, commercially available, unit for use as the tuner may be part number FQ1236/FH-3 available from Philips Electronics of the Netherlands. The demodulated signal 39 may be passed to a remodulator 42, such as one commonly found in video cassette recorders (VCRs), to remodulate the signal to channel 3 or 4, before passing the video signal to the control module remodulated output 33. One suitable, commercially available, integrated circuit for use as the remodulator may be part number MC44BC375UD, available from Motorola Corporation of Schaumburg, Ill.

A controller 41 is operatively connected to the tuner 27 and the text overlay means 29. The controller 41, in addition to a microprocessor (not shown), will include a timer 43 including a clock and calendar function, as well as memory storage 45. One suitable, commercially available, integrated circuit for use as the controller may be part number ATMEGA32-16AC, available from Atmel Corporation of San Jose, Calif. Various commercially available programmable logic devices would be found suitable for use as the controller by the person having ordinary skill in the art. The controller 41 may further include an addressable function 44 and may further also be operatively connected to the remodulator 42 to operate a pass-through function for baseband signals 46 which do not need to be remodulated in the case where the monitor 25 has a baseband input. It will be noted that many commercial establishments such as hotels and the like have televisions which only contain a single coaxial input to their tuners rather than baseband inputs.

The controller 41 is equipped to remember or retain the tuner setting or to poll the tuner 27 to determine the tuner channel designation, remember the present channel designation, direct the tuner 27 to switch to a second channel designation, and return to the present channel designation at a particular time according to the timer 43 within the controller 41. The controller 41 may further be operably connected to switch the control module output jack 33 between the remodulator output 47 and the baseband video signal input 38 in the case where the remodulator 42 does not have a pass-through baseband output 35.

The text overlay means 29 accepts text data from the controller memory 45 and places said text in baseband video format 49 for insertion into the demodulated baseband signal 39 from the tuner 27 for display over the video monitor 25. One suitable, commercially available, integrated circuit for use as the text overlay means may be part number M35060-002SP, available from Mitsubishi Electric Corporation of Japan. Text overlay circuitry as known in the art is capable of overlaying the text anywhere on the screen, and desirably provides vertical and horizontal scrolling functions as well as still presentation. The controller 41 is also operatively connected to the text overlay means 29 for overlaying said text at a particular time, and for a particular amount of time, according to the operator instructions and timer 43. If the control module 21 is intended to be permanently connected to a text input interface such as a PC, the timer of the text input interface may in some cases be relied upon for scheduling video overlay or alternative video events.

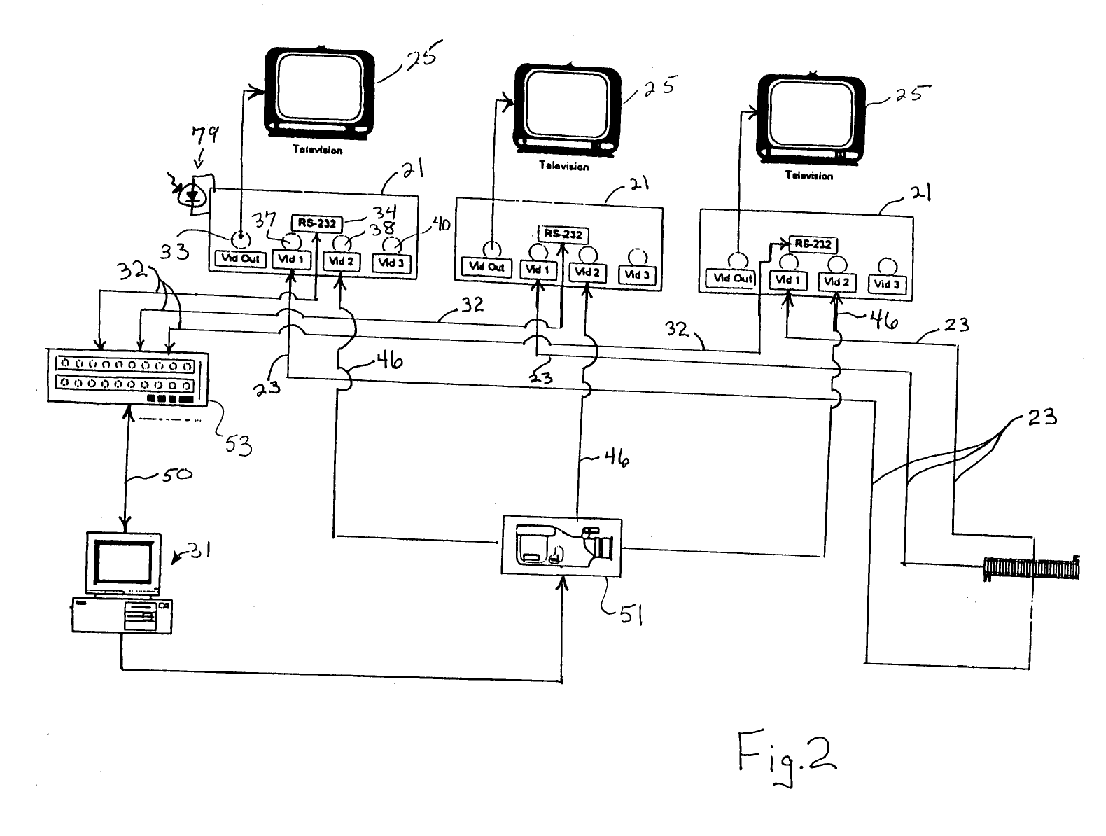

FIG. 2 illustrates an array of self-contained box type control modules 21 in one embodiment of the invention. Each control module 21 is self-contained and may include the functionalities described with respect to FIG. 1, as well as other features described below. An existing video distribution cable 23, such as a cable, satellite, or broadcast feed, is connected to a first video in jack 37, while alternate video sources 51 can be connected to a second video in 38 as well as a third video in 40, etc. Each control module 21 has a video-out jack 33 connected to a corresponding television 25. Text information can be sent to the control modules 21 either via a permanent PC connection, or by temporarily connecting another digital text means containing operating software for the control module, such as a PDA or laptop computer, via each control modules' serial port 34. The serial communications will desirably run at a relatively low baud rate in order to achieve maximum cable length. For example, a rate of 1200 baud should allow a cabling run of about 150 feet.

An external AC/DC converter power supply unit (not shown) and a power switch (not shown) may be provided to each stand alone box control module 21 in this embodiment of the invention. Battery backup 77 (FIG. 1) is further desirably provided for each control module 21 in the event of power failure.

Each control module 21 is may be equipped with Up/Down channel selector buttons (not shown) and an antenna/cable tuner mode switch (not shown). In a multiple unit installation, such as shown in FIG. 2, the control modules 21 can be controlled via a multiple serial port control module 53 connected to a single communications line 50 connected to the serial port on a PC serving as the text input interface 31. Provision of an infra-red remote control sensor 79 will allow channels to be selected via a remote control unit, the front panel buttons (not shown), or the text overlay interface (PC) 31. The alternative video source 51 may further be triggered by the text input interface 31 in some embodiments.

A common operating scenario for any selected control module 21 will be to run some specialized video at a programmed time. For example, assume that at 8:00 PM the operator wishes to change a particular control module 21 from television channel five to (alternate) video input #2 for 2 minutes. The controller 41 (FIG. 1) will remember that the tuner 27 was on channel five (or poll the tuner to determine which channel it is on), switch to video input #2 for 2 minutes, then switch back to the television channel 5. The alternate video inputs may be output as baseband signals or may be modulated for a selected channel of the monitor 25.

For text overlay functions, the operator may pick from several predefined messages in the text input interface 31, as well as create custom text, dependent upon the level of text input interface capability. Because the control modules are autonomous, each control module 21 may run different messages depending on the operator's choices. Messages may be scheduled to run continuously, at specific times for specific periods (e.g., every hour for 10 minutes), or one time only. Text overlay activation may be selectable by day of the week, or calendar day, as well.

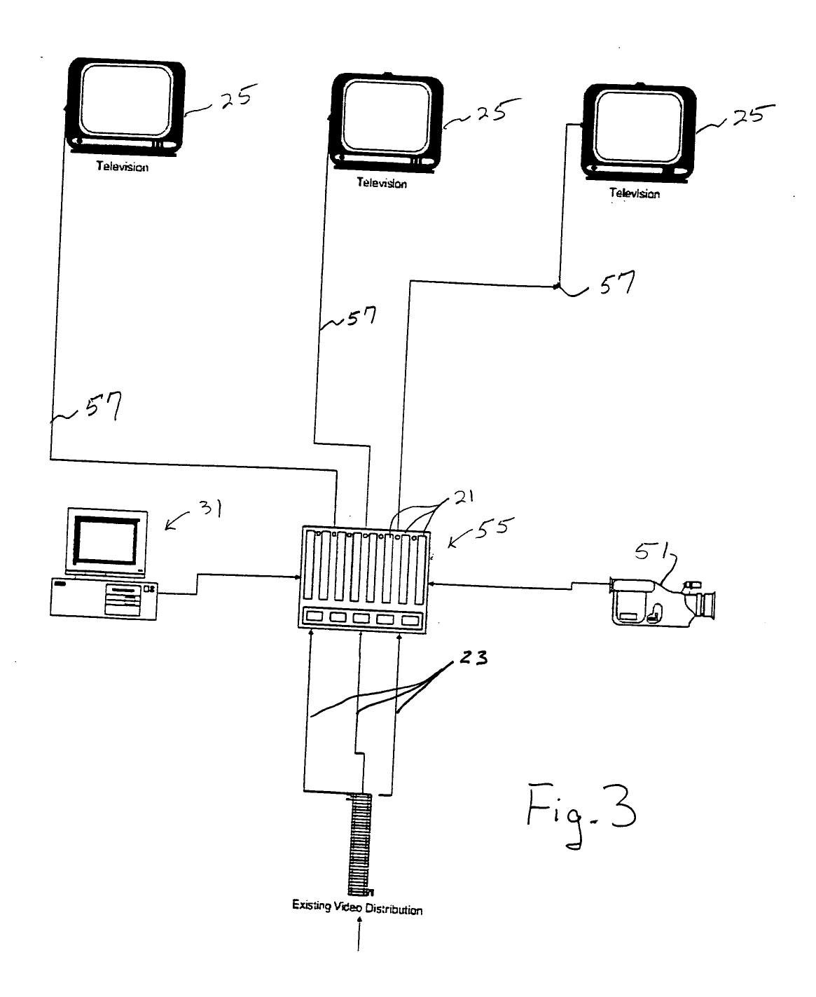

FIG. 3 illustrates a rack mounted embodiment 55 of the present invention. Each control module 21 is rack mounted and may include a rack mount card with edge connectors (not shown) for accepting commercial video inputs 23. It is further desirable to include edge connectors on the card-embodied control modules which can connect to existing cabling 57 to the televisions 25. The rack mounted control module cards 21 of FIG. 3 may thus have one or more video input jacks, or a bus connector input, or both. Internal signal distribution between control modules such as for control signals, or video signals, or both, and especially alternative video sources 51, can be simplified by connecting each control module 21 to a central bus or buses within the rack. It will be noted that no extended serial bus communication lines 32 will be required to be run from the text input interface 31 to each control module 21 in this embodiment.

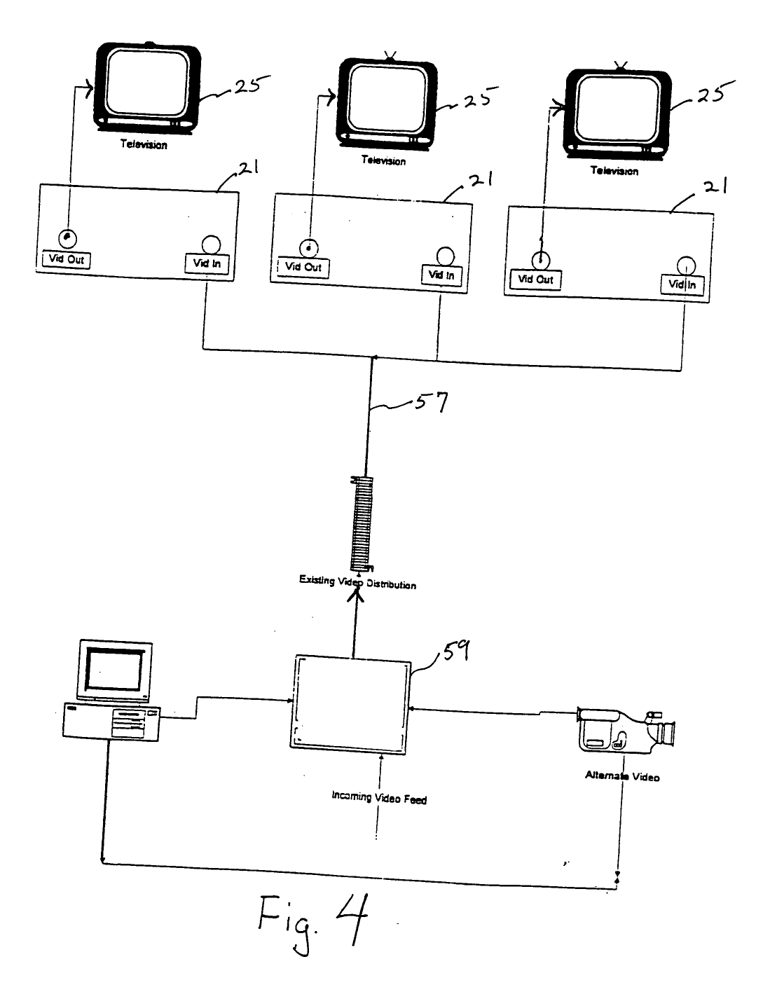

FIG. 4 illustrates another alternative embodiment of the present invention. The embodiment of FIG. 4 includes a so called “agile modulator” 59, as known in the art, which can be selected to modulate both the control signals and text signals from the text input interface 31 and the alternative video signals from the alternative video sources, to any tuner channel. After modulation, all signals may be sent to the individual control modules 21 on existing cabling, e.g., the coaxial cable 57 of the existing video distribution infrastructure. The control modules 21 will then operate as described above to provide text overlay and alternative video capability for the monitors 25.

Each of the above embodiments of the control module of the present invention may include addressable functionality which will enable the control modules to be controlled individually or by groups, e.g., according to a functional or physical area of a commercial establishment. Addressing may be provided, e.g. through the controller 41 or a DIP switch on the control module, etc. For example, the control modules may be grouped by floors in a large office building. In such embodiments, an alert system containing preprogrammed instructions, for example emergency or disaster instructions detailing exit or escape routes can be directed to, or preprogrammed into, each individual control module or group of control modules. Thus, for example, in the event of a fire, the text input interface 31 could be connected to a sensor in series with the building's alarm and/or sprinkler system to automatically switch a television controlled by the control module 21 to an additional channel displaying exit routes, or display text overlay containing emergency instructions, or both.

The present invention is described in terms of an exemplary embodiment. The person having ordinary skill in the art will appreciate that the techniques and systems described herein can be applied to a number of architectures and the present invention is not intended to be limited to the described exemplary embodiments. Thus, while certain exemplary embodiments have been put forth to illustrate the present invention, these embodiments are not to be taken as limiting to the spirit or scope of the present invention which is defined by the appended claims.

We claim:

1. A control module including a tuner and text overlay means for providing text to an existing television system infrastructure, the control module comprising:
a) a control module output for connection to a video monitor;
b) a signal input means for accepting video signals and routing the video signals to the tuner;
c) the tuner for accepting the modulated video signals, demodulating the video signals, and outputting the demodulated signals to the control module output;
d) a controller operatively connected to the tuner, the controller including a timer,
the controller being able to determine a present tuner channel designation, remember the present designation, switch the tuner to a second channel designation, and return to the present designation at a particular time, and
e) the text overlay means for placing the text in baseband video format for display over the video monitor, the controller also operatively connected to the text overlay means for overlaying the text at a particular time.

2. Apparatus, including a tuner and text overlay, for providing text to an existing television system infrastructure, comprising:
I) a text input interface allowing an operator to select and output at least one of preselected or free text;
II) a control module including:
a) a controller for managing the text input interface output;
b) a means for connecting the text input interface output to the controller;
c) a modulated signal input means for accepting modulated video signals and routing to the tuner;
d) a alternative video signal input means for accepting alternative video signals;
e) the tuner for accepting the modulated video signals, demodulating the modulated video signals, and outputting the demodulated signals to the control module output;
f) the controller operatively connected to the tuner, the controller including a timer;
g) the controller being able to determine a present tuner channel designation, remember the present channel designation, switch the tuner to a second channel designation, and return to the present designation at a particular time;
h) the controller further being able to switch the control module output between the tuner output and the baseband video signal input means; and
i) the text overlay means for accepting text from the text input interface and placing said text in baseband video format for display over the video monitor, the controller also operatively connected to the text overlay means for overlaying said text at a particular time.

3. The apparatus of claim 2 wherein the control module further comprises a remodulator for remodulating baseband video signals.

4. The apparatus of claim 2 wherein the control module further comprises an infrared remote control apparatus.

5. The apparatus of claim 2 wherein the control module is a self-contained in a single unit.

6. The apparatus of claim 2 wherein the control module is addressable.

7. The apparatus of claim 2 wherein the apparatus includes an active modulator for accepting, demodulating, and remodulating signal inputs.

8. The apparatus of claim 2 wherein the apparatus is connected to an alert system.

9. The apparatus of claim 2 wherein the controller further performs the switching of the tuner for a preselected amount of time.

10. The apparatus of claim 2 wherein the controller further performs the switching of the text overlay for a preselected amount of time.

11. Apparatus, including a tuner and text overlay means, for providing text to an existing television system infrastructure, comprising:
I) a text input interface allowing an operator to input at least one of preselected or free text and instructions for the display of the at least one of preselected or free text to a text overlay means;
II) a control module including:
a) a controller operatively connected to the tuner, and connectable to the text input interface;
b) a modulated signal input means for accepting modulated video signals and routing to the tuner;
c) a baseband video signal input means for accepting baseband video, and an output means for connection of the baseband video signal to a video monitor;
d) the tuner for accepting the modulated video signals and demodulating the modulated video signals;
e) a remodulator for remodulating demodulated video signals;
f) the controller further including memory means for storing received text from the text input interface, and the controller further including a timer;
g) the controller being able to determine a present tuner channel designation, store the present designation, switch the tuner to a second channel designation, and return to the present designation at a particular time; and
h) the text overlay means for accepting text from the text input interface and placing said text in a baseband video signal, the controller also operatively connected to the text overlay means for overlaying said text at a specified time.

12. The apparatus of claim 11 further comprising a plurality of video monitors and a plurality of control module modules in a single-location television infrastructure, each video monitor having an individual control module dedicated thereto.
